(19) United States
(12) Patent Application Publication
(10) Pub. No.: US 2025/0000041 A1
(43) Pub. Date: Jan. 2, 2025

(54) METHODS AND SYSTEMS FOR VERTICAL HYDROPONIC PLANT CULTIVATION

(71) Applicant: RediFarms LLC, Westfield, NJ (US)

(72) Inventors: GREGORY J. REDINGTON, Westfield, NJ (US); MICHELE MODESTINO, Westfield, NJ (US)

(73) Assignee: RediFarms LLC, Westfield, NJ (US)

(21) Appl. No.: 18/756,046

(22) Filed: Jun. 27, 2024

Related U.S. Application Data
(60) Provisional application No. 63/523,369, filed on Jun. 27, 2023.

(51) Int. Cl. A01G 31/06

(52) U.S. Cl. CPC A01G 31/06

(57) ABSTRACT

Vertical hydroponic plant systems and methods are provided herein. The systems may include vertical hanging wall systems, vertical mounted wall systems, seed soaking and/or watering systems, and linear production systems for larger plants. Various methodologies may be employed to provide optimal lighting and nutrients for plant growth.

### CROSS-REFERENCE TO RELATED APPLICATIONS

This application claims priority to U.S. Application Ser. No. 63/523,369 filed on Jun. 27, 2023, the contents of which are herein fully incorporated by reference in its entirety.

### BACKGROUND OF THE EMBODIMENTS

Plants require certain nutrients in order to grow and be healthy. Plant nutrients are typically divided into macronutrients and micronutrients. The macronutrients are sometimes divided into primary macronutrients and secondary macronutrients. Examples of primary macronutrients include nitrogen, phosphorus, and potassium. Examples of secondary macronutrients include sulfur, calcium, and magnesium. Examples of micronutrients include iron, molybdenum, boron, copper, sodium, zinc, nickel, aluminum, and silicon. When plants are grown in soil, the soil provides many, if not all, of these vital nutrients. In some cases, fertilizer may be added to the soil to provide nutrients.

Hydroponics is a method of growing plants without the use of soil. A hydroponic system and/or method may use water containing plant nutrients to facilitate plant growth. The field of the embodiments of the present invention relates generally to vertical hydroponic plant production systems and methods employing those systems. In particular, the present invention and its embodiments relate to a vertical hydroponic plant production system that allows for vertical hydroponic plant production in a fraction of the space necessary for traditional plant production techniques.

Traditional hydroponic systems and methods often direct their focus on horizontal production techniques which, in turn, are subject to space constraints. Prior vertical hydroponic systems and methods have either been impractical, expensive to operate, or inefficient. Often these systems utilize a growth medium that becomes heavy when saturated, is clogged by roots, and/or requires a prohibitive amount of maintenance. In addition, conventional technology makes it difficult to allow for the in-store display of live, growing vegetables and is not conducive to vegetable and herb sales to customers where customers can pick their own produce. Little technology exists that allows vertical plant displays that are highly scalable.

For example, U.K. Patent Application 2532467 pertains to a vertical hydroponic growing system that comprises an elongated housing having a tubular outer wall with a longitudinally extending slot leading to an interior of the housing for holding hydroponic growing medium material. A plant held by the growing medium material grows out through the slot. The housing has an upper fluid inlet for supplying a nutrient solution to the growing medium and a lower fluid outlet for recovering unused nutrient solution. Within said housing interior is at least one transversely facing abutment which sub-divides said interior volume into at least two longitudinally extending contiguous portions, including a first hydroponic growing portion and an aeroponic growing portion, the hydroponic growing portion being between the slot and the aeroponic growing portion. The housing has at least one removable panel for providing access to the interior volume of the housing for the loading of the hydroponic growing medium.

U.S. Pat. No. 10,856,480 pertains to a system and method for cultivating plants. The system may include a tower structure having a vertical series of vessels for holding a netted pot or other container. The system may have a pressurized irrigation system that is in fluid communication with each vessel. The system may further include lamps to provide an adequate light source. The system may also include sensors, monitors, and controls to establish and maintain environmental conditions suitable for proper plant growth. The system may further be implemented as a scalable system in which multiple tower structures may be installed into a scaffold system. Sets of towers may be slidably affixed to a scaffold such that the towers may be slid along a track thereby creating easy access to the plants, vessels, lights, and the irrigation system. The system may be expanded to include multiple scaffolds affixed to a skeletal frame or compartment interior.

Further, U.S. Pat. No. 9,591,814 pertains to a light-weight, modular, adjustable vertical hydroponic growing system and method of Native American design for cultivation plants and beneficial soil organisms (BSO's) in symbiotic combination. Forest-like arrays of fully rotatable and demountable grow tubes are suspended within climate moderating greenhouses, optionally from conveyor tracks. The tubes are filled with light-weight, porous 100% inorganic grow media predominately comprised of expanded volcanic or recycled glass granules. The grow tube arrays are provided with an insulated, overhead-mounted fertigation distribution system delivering metered intermittent flows from insulated mixing and holding tanks. The flows are recycled via an insulated return piping system to maintain cool fertigation temperatures near those of natural groundwater. Fertigation supply mains provided with vortex flow induction devices impart rotational momentum to flows for delivery of uniform aerated fertigation to plants and BSO's via a combination of open-tube emitters and gravity flows within grow tubes.

However, known hydroponic and/or aeroponic systems and methods fail to account for the structures and methods of the present application.

### SUMMARY OF THE EMBODIMENTS

In general, the present invention and its embodiments provide for hydroponic plant cultivation systems and methods. As is described herein, it is generally known to utilize both vertical and horizontal growing methods in hydroponic systems. However, the present invention and its embodiments utilize modular components that can be readily removed from the growing room for harvesting and cleaning. Further, all of the components of the present invention are “human scale” meaning that the systems can be assembled, moved, and reassembled by hand. In yet other embodiments, the assembly, moving, cleaning, and reassembly of the components of the present invention may be automated. In at least one embodiment, the panels (as defined below herein) are configured to hang from supporting structures thereby providing a clear floor space for movement and cleaning in and around the panels and any ground mounted/supported trough(s). All components of the embodiments of the present invention are completely “plug-and-play” such that between harvests the entire line (as defined below herein) can be replaced with fresh clean components which reduces downtime and eliminates any cleaning process/chemicals/spills in the growing room.

In at least one embodiment there is, a hydroponic plant cultivation apparatus having a first panel with a plurality of first apertures; a plurality of first elbows engaged with the plurality of first apertures with one elbow engaging with one aperture; a second panel having a plurality of second apertures; a plurality of second elbows engaged with the plurality of second apertures with one elbow engaging with one aperture; and the trough being positioned above, at, or below a bottom of the first panel and a bottom of the second panel.

The hydroponic plant cultivation apparatus may further include at least one lighting apparatus.

The hydroponic plant cultivation apparatus may further include a plurality of securement mechanisms configured to selectively secure a position of the first panel and the second panel.

The hydroponic plant cultivation apparatus may further include a dispersion system.

The hydroponic plant cultivation apparatus may also include where the dispersion system is coupled to the hydroponic plant cultivation apparatus along a top side of the hydroponic plant cultivation apparatus.

In another embodiment of the present invention, there is a hydroponic plant cultivation apparatus having a first panel with a plurality of first apertures, wherein the first panel has at least one handle on an outer surface of the first panel; a plurality of first elbows engaged with the plurality of first apertures with one elbow engaging with one aperture; a second panel having a plurality of second apertures, wherein the second panel has at least one handle on an outer surface of the second panel; a plurality of second elbows engaged with the plurality of second apertures with one elbow engaging with one aperture; at least one lighting element positioned at distance from the outer surface of the first panel and the outer surface of the second panel; a trough positioned above, at, or below a bottom of the first panel and a bottom of the second panel; and a dispersion system configured to disperse water and/or nutrients on an interior of the first panel and the second panel.

In yet another embodiment of the present application there is a hydroponic plant cultivation apparatus having a first panel with a plurality of first apertures, wherein the first panel has at least one handle on an outer surface of the first panel; a plurality of first elbows engaged with the plurality of first apertures with one elbow engaging with one aperture; a second panel having a plurality of second apertures, wherein the second panel has at least one handle on an outer surface of the second panel; a plurality of second elbows engaged with the plurality of second apertures with one elbow engaging with one aperture; at least one slidable lighting element positioned at an adjustable distance from the outer surface of the first panel and the outer surface of the second panel; a trough positioned above, at, or below a bottom of the first panel and a bottom of the second panel; a light array positioned a distance from an outer surface of both of the first panel and the second panel; a dispersion system configured to disperse water and/or nutrients on an interior of the first panel and the second panel; and a slidable track engaged with at least one of the first panel and the second panel.

In general, the present invention succeeds in conferring the following benefits and objectives.

It is an object of the present invention to provide a vertical hydroponic plant system that is modular.

It is an object of the present invention to provide a vertical hydroponic plant system that can host a number of different cultivars.

It is an object of the present invention to provide a vertical hydroponic plant system that can be disassembled, cleaned, reassembled, and the like by hand.

It is an object of the present invention to provide a vertical hydroponic plant system that is hung from support structures above ground level.

It is an object of the present invention to provide a vertical hydroponic plant system that is suspended from a support structure.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 is a perspective view of a line of panels in accordance with an embodiment of the present invention.

FIG. 2 is a close-up view of an elbow integrated with a grow panel in accordance with an embodiment of the present invention.

FIG. 3 is an interior view between two grow panels showing a water/nutrient dispersion system in accordance with an embodiment of the present invention.

FIG. 4 is a top-down view of a pump associated with an embodiment of the present invention.

FIG. 5 is a top-down view of a trough associated with an embodiment of the present invention.

FIG. 6 is a view of an alternative and separate pump/reservoir mechanism for use with an embodiment of the present invention.

FIG. 7 is a side view of multiple grow panels demonstrating integrated lighting elements and supporting track elements associated with an embodiment of the present invention.

### DETAILED DESCRIPTION OF THE EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

As used herein, the term “panel” means a single sheet of flat rigid smooth composite substrate having holes or apertures therethrough in which the plants grow. The hole sizes, spacing, and pattern could vary with the cultivar the panels are designed for. Panels further have handles attached thereto to facilitate handling and removal/replacement of the panels at the harvesting of the plants as well as to facilitate cleanings between harvestings or when otherwise needed.

As used herein, the term “wall” means two back-to-back panels separated by a distance. The distance may vary but are preferably separated by about four inches (4″) leaving an open area therebetween which water runs to feed the roots of the plants.

As used herein, the term “line” means a series of walls arranged linearly creating a line of walls that preferably share the same water reservoir and trough.

As used herein, the term “elbows” means molded tubular plastic pieces that engage with the holes or apertures in the panels. The elbows are open tubes with a built-in angle and a flange at the panel end. The length, diameter, and angle of the elbows can vary with the cultivar the elbows are intended to secure to the panel.

As used herein, the term “trough” means a continuous drain mechanism for the line used to carry the water back to the reservoir and/or pump.

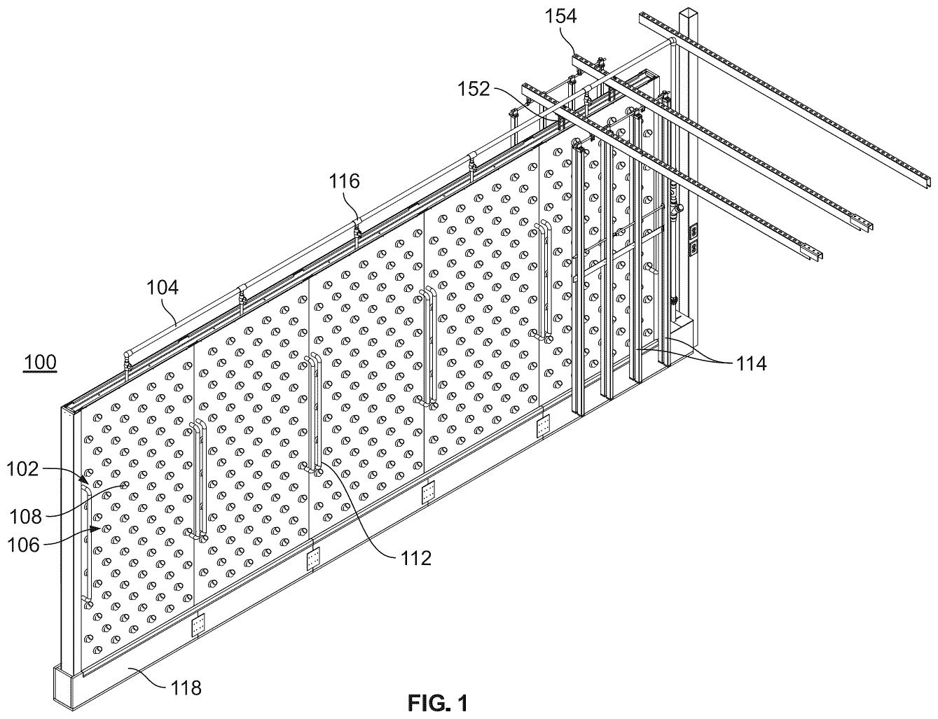

Referring now to FIG. 1, shown is a vertical hydroponic plant system 100 having a first panel 102, a second panel 104, a plurality of apertures 106, a plurality of elbows 108, a handle 112, a suspension clip 152, a suspension channel 154, a lighting element 114, a dispersion system 116, and a trough 118.

In a preferred embodiment, the first panel 102 and the second panel 104 are suspended from an upper (relative to the panels) support structure. The upper support structure preferably comprises at least one support channel 154 and at least one support clip 152. In some embodiments, the support channel 154 is an overhead aluminum up-turned C-channel that runs the length of the line. Secured to an upper inside or interior surface of the panels 102, 104 is a support clip 152 which may preferably be an aluminum inverted “J” clip. This support clip 152 is fastened to the panel 102, 104 and further clips or hangs from the support channel 154 to hang or otherwise suspend the panel 102, 104 securely. The trough 118 may either be supported by the same overhead support channel 154 via metal (or other suitable material) braided cables that connect directly into the trough 118, or the trough 118 may be supported (e.g. resting upon) by the floor in the growing environment. Spacers, in at least one embodiment formed of a composite, are present on the inside of the panels 102, 104 and/or trough 118 to ensure the back-to-back panels of each wall remain properly lined up or distanced from one another and the trough 118.

Each wall comprises at least one and preferably two panels (a first panel 102 and a second panel 104) upright and back-to-back and separated by a distance in accordance with the above-described support channel(s) 154 and support clip(s) 152. In an alternative embodiment, the vertical hydroponic plant system 100 is a wall system comprising a number of modular wall frames arranged end-to-end into a line. The number of modular wall frames may vary and in a preferred embodiment may number between about 1 frame and about 20 frames. The frames may consist of four-inch composite planks that produce a three-sided rectangular frame each panel 102, 104 is secured to, however, other suitable configurations are envisioned under the purview of this invention.

In at least one embodiment, a bottom side of the panels 102, 104 may rest above, upon, or be suspended above the trough 118. The bottom side or edge of the panels 102, 104 is open to allow the water flowing down inside the panels 102, 104 to drop into the trough 118.

Each of the first panel 102 and second panel 104 forms a “wall” that covers two back-to-back panels (with elbows extending outwardly from each panel) separated by a distance therebetween. The distance between the inner surfaces of the panels 102, 104 may vary but are preferably separated by about four inches (4″) leaving an open interior area between panels 102, 104 when suspended which allows water to run down the interior or inner surfaces of the panels 102, 104 to feed the roots of the plants. Each of the first panel 102 and the second panel 104 (as well as any other panels used in the system) may have anywhere from about ten to about two hundred apertures 106 and more preferably about fifty to about eighty-five apertures 106, and most preferably about eighty-four apertures 106. The apertures 106 are configured to traverse a thickness of the panel 102, 104 from an outer surface of the panel 102, 104 to an inner surface of the panel 102, 104. However, the number, size, and spacing of the apertures 106 can vary within the respective panel depending on the desired cultivar amongst other considerations in the system. For example, if there were eighty-four apertures 106 in the panels to form one wall, then the wall has 168 total plant positions.

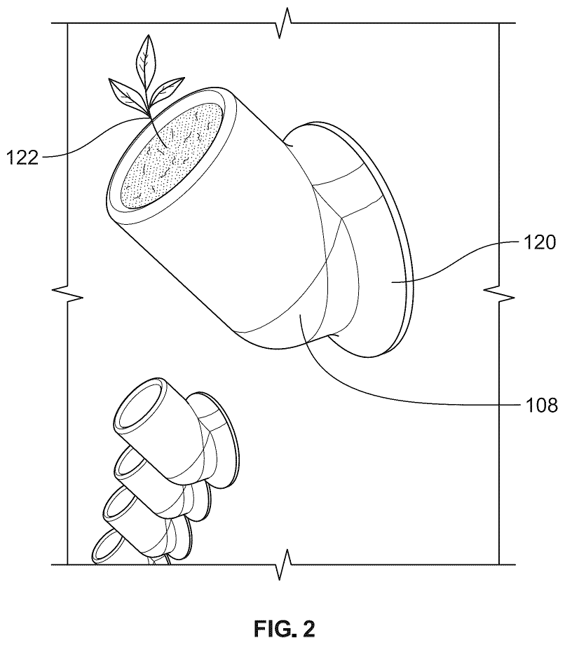

In order to support the seedlings and eventual plants on each of the panels 102, 104, an elbow 108 is fit snugly preferably into each aperture 106 in the panel 102, 104. The elbow 108 preferably has a slightly flared flange (see FIG. 2) that sits against an outer surface (the outer surface being the visible surface once the panel(s) is secured in place) of the panel 102, 104 around the aperture 106 such that a terminal end of the elbow (not shown) is flush with the inside surface of the panel 102, 104. This enables the uninterrupted flow of water and/or nutrients down the inside surface of the panel 102, 104. In at least one embodiment, the elbows 108 are adhered to the outer surface of the panel 102, 104 with an adhesive or other suitable means (e.g., mechanism means).

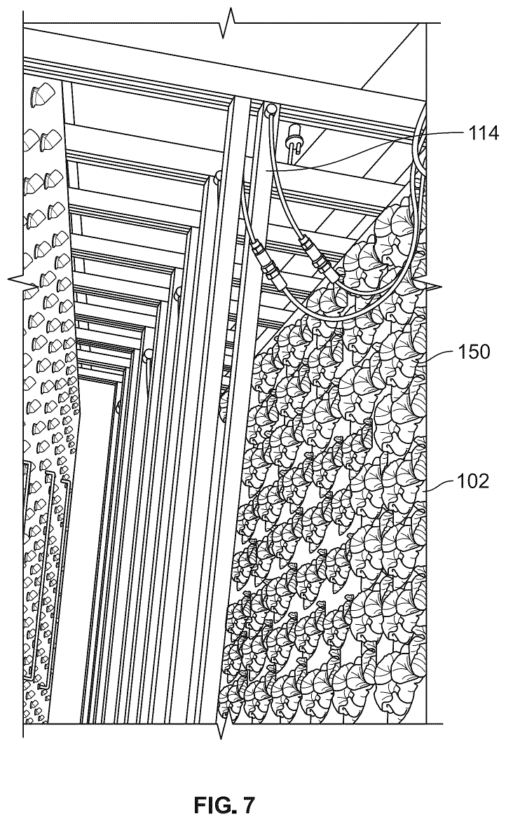

The light element 114, as shown in FIGS. 1 and 7, is preferably vertically hanging light emitting diode (LED) strip lights. In at least one embodiment, the LED light strips are 8′ long and are spaced 12″ apart, and secured together as an array. These light arrays are hanging and are able to slide towards and away from the panel 102, 104 as needed for optimum lighting intensity and to make room for human access to the panel for quality control checks and harvesting.

In at least one embodiment, the light arrays secure up to three or more vertical lights together but they can be made to combine more or fewer lights. Lighting intensity and duration are controlled with an electronic integrated control module or web/mobile application.

As shown in FIG. 2, pods or plugs with approximately 1-3 week old seedlings are inserted into the elbow 108 as desired, which holds the seedlings in the correct position. This allows the plant roots to grow past the terminal end of the elbow 108 and hang into the open interior of the wall thereby allowing the seedlings to uptake water and/nutrients from the dispersion system 116. The seedling is held upright at an angle by the elbow 108 and grows towards the light element 114 facing the panel 102, 104. However, in some embodiments, younger or older plants may be inserted into the elbows 108. In a preferred embodiment, each elbow 108 is identical, however, in some embodiments, different shapes and sizes of elbows 108 may be used to accommodate different types of plants and/or plants during different growth stages.

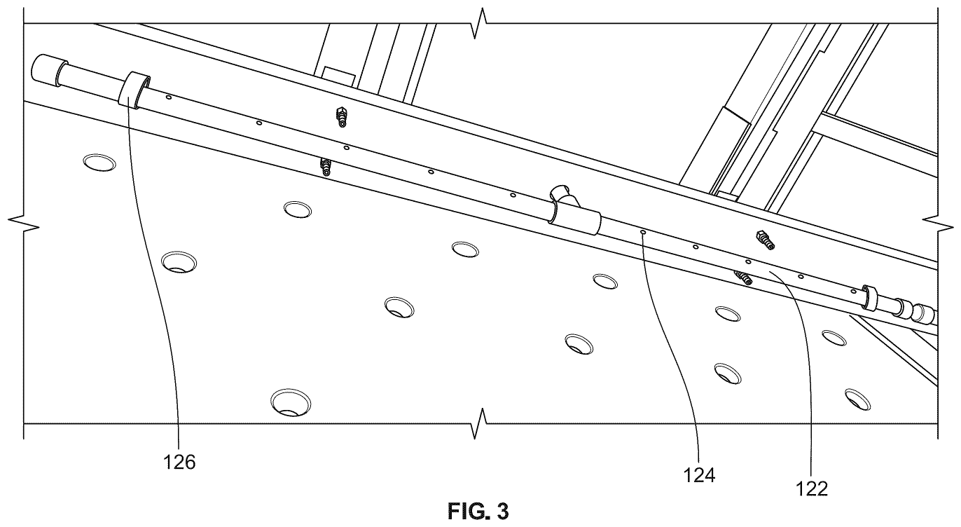

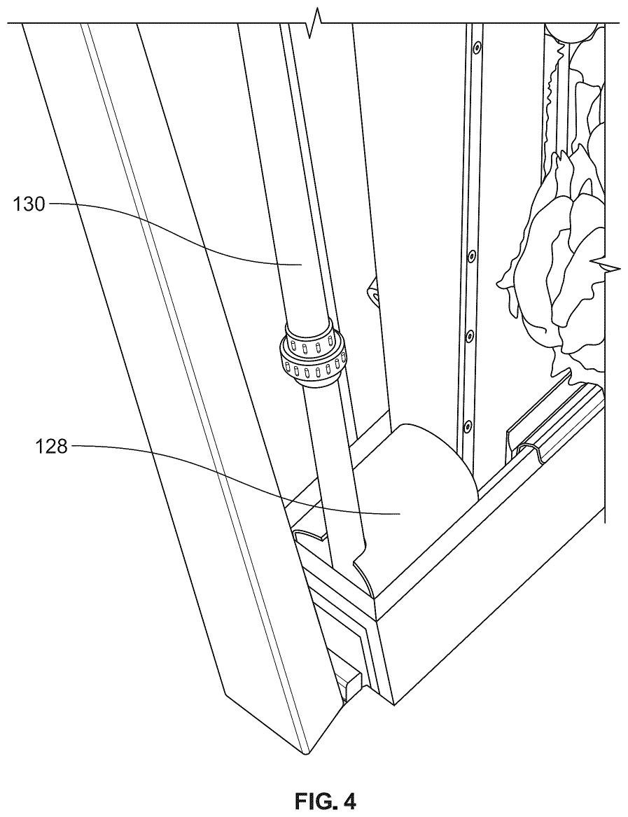

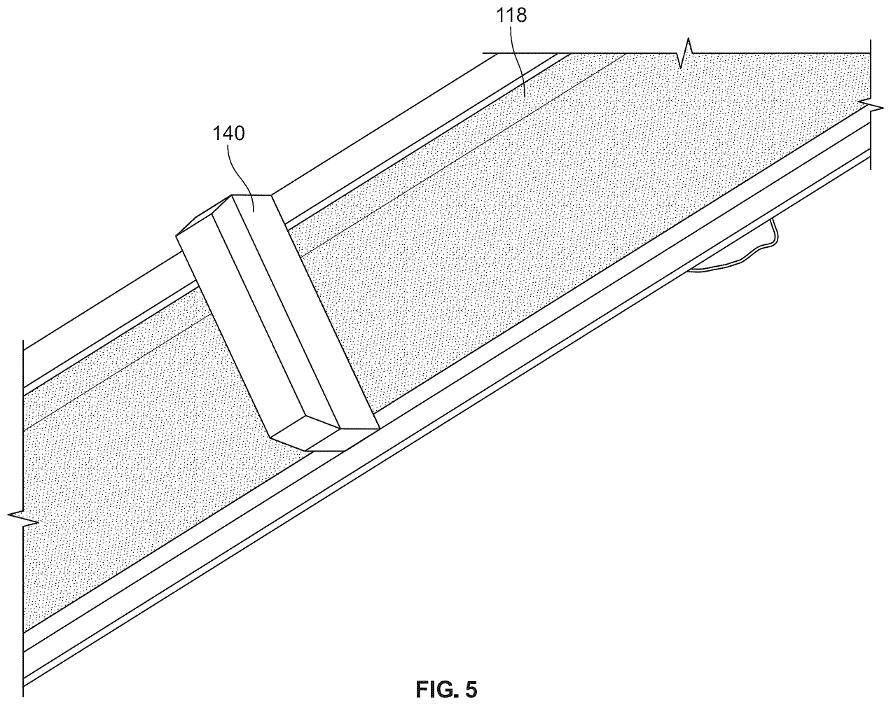

FIGS. 3-5 illustrate the main components of the dispersion system 116 in accordance with the embodiments of the present invention. Primarily the dispersion system 116 comprises dispersion piping 122, openings 124 in the dispersion piping 122, supports 126, pump 128, and return piping 130.

Water and/or nutrients are delivered via a top surface of the vertical hydroponic plant system 100 and dispersed along an interior or inner surface of each panel 102, 104, striking the interior surface of the panel 102, 104 and running downwards along the panel surface, past the apertures 106 and elbows 108 and finally down into the trough 118. The pump 128 then pumps the water and/or nutrients from the trough 118, via the return piping 130, to complete the dispersion system 116. During dispersion of the water and/or nutrients, the water and/or nutrients cascade down across the interior surface of the panel 102, 104 thereby contacting the roots of the plant, which pass through the elbow and into the interior of the wall to permit water uptake by the plants.

Further, the dispersion piping 122 may comprise a single PVC pipe above the support channel(s) 154 with “T” joints centered at each panel 102, 104 going through a hole in the support channel(s) 154 to another “T” connecting to another PVC pipe that is at least the width of the panel 102, 104 with holes to spray both panels 102, 104 within the wall structure.

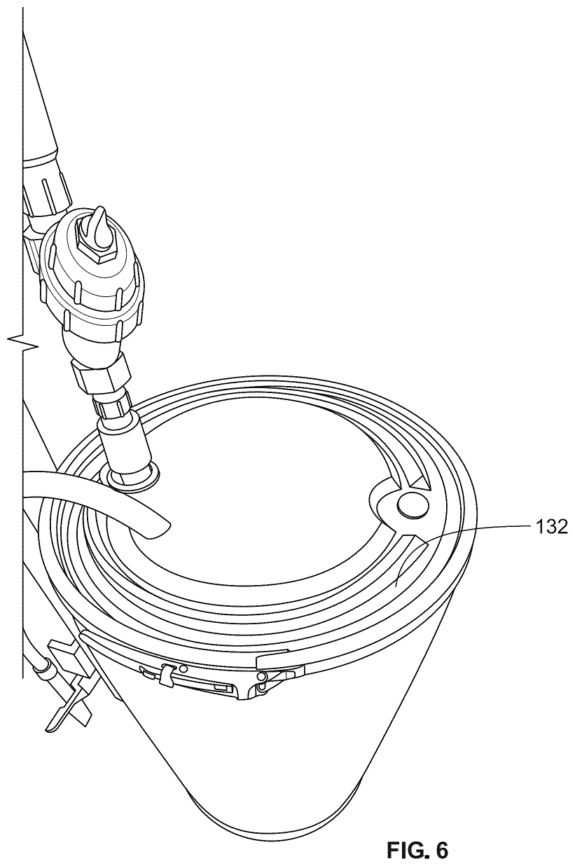

In one embodiment, and as shown in FIG. 6, rather than a pump 128 directly placed in the trough 118, there is a reservoir 132 designed and configured to collect the water and/or nutrients once it has fallen into the trough 118. The recycled water is stored in the reservoir 132 which may hold anywhere from about 20 to about 100 gallons of water (or more) per line, depending upon the number of walls in a given line or the type and stage of the cultivar of plant being grown at the time.

As shown in FIGS. 1 and 4-5, the panels or walls (depending on configuration) preferably connect to a water collection trough that spans the length of the line. The trough 118 has spacers or blocking elements to separate each wall in the line from each other and keep light out of the trough 118 from between the walls forming the line. Troughs 118 may have a slight pitch to facilitate water flow down to one end of the line to a sump reservoir or pump as described herein.

As shown in FIGS. 1 and 7, the walls (panels, supports, etc.), light elements 114, and dispersion system 116 are all configured to hang from a supporting structure or a support channel 154 positioned there above. This a support channel 154 may be made from structural steel beams and columns supported on the floor. Integrated with the steel beams are “Unistrut” (or similar) members with clamps and hanging fasteners or in some embodiments sliding fasteners as described above herein.

For a single-line system, a single beam (with a column at each end) or two beams with four columns, can run above and parallel with the line with perpendicular “Unistrut” arms sticking out each side to support the lighting arrays. The columns can be bolted to or resting upon the floor or have an extension leg sticking out on two sides in order to stabilize the column and remaining structures. The trough 118 may also hang from this structure, or it may be independently resting on the floor.

In practice and use of the embodiments of the present invention, workers can detach and remove the panel 102, 104 from the growing room. The panel 102, 104 is then preferably transported by hand or on a cart to the harvesting area. After harvest, panels 102, 104 are then moved to the cleaning area for sanitation and then moved to a staging area to await planting. Once planted, panels 102, 104 will be returned to the growing room and mounted and secured back into place.

When a series of lines are laid out next to each other, such as in a commercial farm setting, the lines are preferably spaced parallel to each other, about 36″ apart with back-to-back hanging lights between each line. In this situation, each light array would secure vertical lights facing back-to-back and shining light away from each other onto the panels facing each other from neighboring lines.

In yet further embodiments, the panels 102, 104 may have a single composite flap positioned on the panel's interior face down the full length of one side. This flap is configured to produce an interlocking effect when panels are placed immediately adjacent to one another when in series within the line. The exposed sides of the first and last wall in the line have “C” shaped end caps that run the vertical length of the panels to make a water and light barrier. These are supported by the hanging or suspended support channel 154 overhead. In such an embodiment, there are no vertical barriers for the interior watering system within a line. The entire inside is open from one vertical end cap to the other. The watering piping or dispersion system 116 can now be continuous, and a single perforated line can now be used for the line's entire length or can stay separated into one or more segments as needed.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A hydroponic plant cultivation apparatus comprising:
a first panel having a plurality of first apertures;
a plurality of first elbows engaged with the plurality of first apertures with one elbow engaging with one aperture;
a second panel having a plurality of second apertures;
a plurality of second elbows engaged with the plurality of second apertures with one elbow engaging with one aperture;
a support coupled to at least one of the first panel and the second panel;
a trough positioned at or below a bottom of the first panel and a bottom of the second panel.

2. The hydroponic plant cultivation apparatus of claim 1 further comprising at least one lighting apparatus.

3. The hydroponic plant cultivation apparatus of claim 1 further comprising a plurality of securement mechanisms configured to selectively secure a position of the first panel and the second panel.

4. The hydroponic plant cultivation apparatus of claim 1 further comprising a dispersion system.

5. The hydroponic plant cultivation apparatus of claim 4 wherein the dispersion system is coupled to the hydroponic plant cultivation apparatus along a top side of the hydroponic plant cultivation apparatus.

6. A hydroponic plant cultivation apparatus comprising:
a first panel having a plurality of first apertures,
wherein the first panel has at least one handle on an outer surface of the first panel;
a plurality of first elbows engaged with the plurality of first apertures with one elbow engaging with one aperture;
a second panel having a plurality of second apertures,
wherein the second panel has at least one handle on an outer surface of the second panel;
a plurality of second elbows engaged with the plurality of second apertures with one elbow engaging with one aperture;
at least one lighting element positioned at distance from the outer surface of the first panel and the outer surface of the second panel;
a trough positioned at or below a bottom of the first panel and a bottom of the second panel; and
a dispersion system configured to disperse water and/or nutrients on an interior of the first panel and the second panel.

7. The hydroponic plant cultivation apparatus of claim 6 further comprising a pump configured to pump the water and/or nutrients through the dispersion system.

8. The hydroponic plant cultivation apparatus of claim 7 wherein the pump is positioned in the trough.

9. The hydroponic plant cultivation apparatus of claim 6 wherein the dispersion system comprises at least one pipe having a plurality of apertures at a top of the hydroponic plant cultivation apparatus.

10. The hydroponic plant cultivation apparatus of claim 7 wherein the pump in the trough pumps the water and/or nutrients into the dispersion system.

11. A hydroponic plant cultivation apparatus comprising:
a first panel having a plurality of first apertures,
wherein the first panel has at least one handle on an outer surface of the first panel;
a plurality of first elbows engaged with the plurality of first apertures with one elbow engaging with one aperture;
a second panel having a plurality of second apertures,
wherein the second panel has at least one handle on an outer surface of the second panel;
a plurality of second elbows engaged with the plurality of second apertures with one elbow engaging with one aperture;
at least one lighting element positioned at distance from the outer surface of the first panel and the outer surface of the second panel;
a trough positioned at or below a bottom of the first panel and a bottom of the second panel;
a light array positioned a distance from an outer surface of both of the first panel and the second panel;
a dispersion system configured to disperse water and/or nutrients on an interior of the first panel and the second panel; and
a slidable track engaged with a top of the hydroponic plant cultivation apparatus.
